(19) United States
(12) Patent Application Publication
(10) Pub. No.: US 2002/0150845 A1
(43) Pub. Date: Oct. 17, 2002

(54) Stabilized CD-4 one-part film developer concentrates

(76) Inventor: Laszlo Papai, Ballwin, MO (US)

Correspondence Address: Howard M. Ellis, Simpson, Simpson & Snyder, PLLC, 5555 Main Street, Williamsville, NY, 14221, US

(21) Appl. No.: 10/071,923

(22) Filed: Feb. 5, 2002

Related U.S. Application Data
(60) Provisional application No. 60/267,347, filed on Feb. 8, 2001.

(51) Int. Cl. G03C 7/413

(52) U.S. Cl. 430/466; 430/490; 430/492; 430/493; 430/450

(57) ABSTRACT

Photographic developer replenisher concentrates comprising more reactive developers, like 4(N-ethyl-N-2-hydroxyethyl)-2 -methylphenylenediamine (CD-4) undergo rapid oxidation, and consequently, have shorten shelf-life stabilities. Hydroxylamine type derivatives, while disclosed as being useful as a class of antioxidants for stabilizing photographic developer replenishers, most were found to impart either inadequate shelf-life stability for CD-4 developer, or interfered with “satisfactory developer performance.” Surprisingly, it was discovered the shelf-life stability of replenisher concentrates comprising CD-4 photographic developer could be extended for periods of 2 years or longer, and also provide satisfactory developer performance when the hydroxylamine antioxidant comprises at least N,N-bis(2 -sulfoethyl) hydroxylamine (SEHA) or a salt thereof.

### CROSS REFERENCE TO RELATED APPLICATION

This application claims the benefit of U.S. provisional application serial No. 60/267,347, filed Feb. 8, 2001.

### TECHNICAL FIELD

The present invention relates in general to photographic development, and more particularly to compositions and methods of making concentrated replenisher compositions for color developing of photographic substrates, and especially photographic films, which concentrates possess improved shelf-life stability.

### BACKGROUND OF THE INVENTION

In the processing of color films and papers the maintenance of developer activity is necessary for uniform development. In recent years, it has become the practice to introduce a replenishing solution to the developing solution in order to replace depleted chemicals and solution carried away. Unless this is done, there will be a depletion of active ingredients, and a build-up of reaction by-products formed as development progresses. Thus, the concentration of reaction by-products may in time exceed the concentration of the developing agent. As the reaction by-products increase the probability of the developer agent being absorbed by the silver halide grain decreases, and the likelihood of uneven or incomplete development increases. Accordingly, replenishment of developing solutions requires restoration of developing agents, preservatives, etc., since their concentrations normally fall in developing processes.

A wide range of photographic replenishers are known. One especially useful color developer replenisher concentrate composition is disclosed by Laszlo Papai in U.S. Pat. No. 5,891,609, which relates to one-part, multi-phase liquid concentrates comprising inter-alia a single ring heterocyclic amide solvent, such as ε-caprolactam.

A further representative example of color developing replenishers is disclosed by Charles R. Darmon, et al in U.S. Pat. No. 6,017,687. The monophase solutions, however, require the developing agents to be exclusively in the free base form. The solutions do not employ developing agents customarily available in an acid salt form. The concentrates are featured for use in developing color paper substrates.

The Darmon et al patent discloses several embodiments of replenishing solutions for processing color paper substrates comprising a wide range of developing agents in free base form stabilized with a myriad of potentially useful antioxidants. Included were the hydroxylamine type antioxidants. This inventor found that replenisher concentrates comprising 4 (N-ethyl-N-2-hydroxyethyl)-2-methylphenylenediamine sulfate developing agent (also known as CD-4), was so sensitive to oxidation that stable concentrates with commercially acceptable, extended shelf-life, i.e., at least one year, could not be readily prepared with most of the antioxidants suggested by Darmon et al.

In particular, most hydroxylamine type derivatives, while disclosed by Darmon et al as being useful as a class of antioxidants for stabilizing photographic developer replenishers, were found to impart either inadequate shelf-life stability for more reactive type developers, like CD-4, or interfered with developer performance. That is, even those hydroxylamine type antioxidants which provided some improvement in shelf-life, often impaired satisfactory developer performance. Consequently, commercial development of one-part color film replenisher concentrates comprising more reactive CD-4 film developer has not been commercially successful.

Accordingly, it would be highly desirable to have a CD-4-containing one-part film developer concentrate for replenishing developing solutions for photographic film, wherein the concentrates possess extended shelf-life stability, i.e., at least about 12 months, and more preferably, from above about 12 to 24 months, or more, and not impede satisfactory film development. Such concentrates should be available either as a monophase or multiphase system and be suitable for use with CD-4 developing agents as mixtures which contain either the salt form of CD-4 or the free base.

### DETAILED DESCRIPTION OF THE INVENTION

It is therefore a principle object of the invention to provide a series of one-part photographic replenisher concentrates with extended shelf-life stability, which are especially useful in development of color films, as well as photographic color papers.

Generally, the one-part liquid concentrated color developer replenisher concentrates of the invention are compositions comprising at least a CD-4 developing agent, namely a 4 (N-ethyl -N-2-hydroxyethyl)-2-methylphenylenediamine sulfate as a free base or free base-salt combinations, and a sufficient amount of the specific hydroxylamine antioxidant suitable for extending the useful shelf-life of the composition, and do so without impairing “satisfactory developer performance.”

For purposes of this invention the expression “satisfactory developer performance,” as appearing in the specification and claims is intended to mean complete and balanced development of the full color dye image, at industry-standard processing conditions (time, temperature, agitation, etc.), to industry-norm statistical standards as measured by densitometric readings of processed control strips.

More specifically the expression “satisfactory developer performance” as appearing in the specification and claims is intended to mean complete and balanced development of the full color image to industry-norm statistical standards as measured by densitometric readings of processed control strips, to within 2 to 3 points of variation from corrected reference aims, including the parameter of base-plus-fog, or Dₘᵢₙ.

The antioxidant found to possess the desired properties for stabilizing CD-4 developer without impairing satisfactory developer performance comprises at least N,N-bis(2-sulfoethyl) hydroxylamine (SEHA) or a salt thereof. Virtually any of the known commercially available salts of this hydroxylamine may be used.

Both the CD-4 (4(N-ethyl-N-2-hydroxyethyl)-2-methylhenylene -diamine sulfate)-containing developer and the specific hydroxylamine, generally known as SEHA are known chemical compounds, commercially available through ordinary channels of commerce. Most CD-4 developer comprises a mixture of the free base and the sulfate salt thereof. SEHA and methods of manufacture are disclosed, for example, in U.S. Pat. No. 5,646,327 (Burns et al) and published European patent application 0 761 647.

The hydroxylamine antioxidant is usually employed as the disodium salt of N,N-bis(2-sulfoethyl)hydroxylamine. Surprisingly, the particular antioxidant employed herein was found to be unique for simultaneously extending the shelf life of the CD-4 containing developer replenisher concentrates, and providing satisfactory developer performance. This inventor found that SEHA is capable of stabilizing concentrates of CD-4 developing agent for 24 months, and more, without engendering the formation of unacceptably high levels of Dₘᵢₙ dye density. Related anti-oxidants did not provide equivalent results with the highly sensitive CD-4 developing agent.

It was also discovered that optionally other hydroxylamine antioxidants may be used in combination with the N,N-bis(2-sulfoethyl)hydroxylamine (SEHA). In each case, however, such combinations are required to have present at least the SEHA hydroxylamine antioxidant, N,N-bis(2-sulfoethyl) hydroxylamine. A representative example of a hydroxylamine combination would be the N,N-bis(2-sulfoethyl) hydroxylamine and diethylhydroxylamine (DEHA), or salts thereof. When DEHA is used in combination with SEHA reduced amounts of DEHA are preferred to keep the Dₘᵢₙ “stain” down to acceptable levels.

It is still a further object of the invention to provide for one-part liquid concentrated color developer replenisher compositions with extended shelf-life stability comprising at least the CD-4 developing agent, containing 4(N-ethyl-N-2-hydroxyethyl)-2-methylphenylenediamine sulfate, a shelf-life extending amount of the hydroxylamine antioxidant, N,N-bis(2-sulfoethyl) hydroxylamine or a salt thereof; a buffer for maintaining the pH of the composition in a range from about 10 to about 12, and a photographically acceptable solvent system.

The buffer system and other components of the solutions may comprise any of the salts and solutions familiar among persons skilled in the art, and which are known to be compatible with other ingredients of the compositions. The solvent system is preferably an organic solvent system. Representative preferred organic solvents include the caprolactams, such as those disclosed by Laszlo Papai in U.S. Pat. No. 5,891,609, the contents of which are incorporated herein by reference. Various polyhydric alcohols, such as ethylene glycol, diethylene glycol may also be employed, such as those described in U.S. Pat. No. 6,017,687, the contents of which are incorporated herein-by -reference.

The one-part developer concentrates may be prepared in monophase format using the above mentioned polyhydric alcohols, for example, or in a multiphase system using such solvents as caprolactam.

The CD-4 developing agent is employed in the concentrates of this invention in a range generally from about 10 to about 100 g/L, and more specifically, from about 25 to about 75 g/L. The hydroxylamine antioxidant, N,N-bis(2-sulfoethyl) hydroxylamine or salt thereof can be employed in a range generally from about 5 to about 75 g/L. When used in combinations with other antioxidants, such as diethylhydroxylamine, the combined antioxidants may be used in a range from about 5 to about 75 g/L.

Useful buffers and other adjuvant ingredients may be included as taught by Papai in his U.S. Pat. No. 5,891,609.

The color developing replenisher concentrates of this invention may be prepared using the following protocol:

The color developing agent (CD-4) is dissolved in an alkaline solution of potassium or sodium hydroxide, for example, and antioxidant/preservative, at least N,N-bis(2-sulfoethyl) hydroxyl-amine or a salt thereof (SEHA), added thereto. The organic solvent, such as ethylene glycol, caprolactam, etc., is added to the alkaline-CD-4 antioxidant solution. In this solution, the salt of the CD-4 developer, such as the sulfate can be filtered out of the solution. To the filtrate, the other usual ingredients of the film developer, like sequestering agents, buffering agents, bromide salt, etc., are added.

If the organic solvent is a glycol or other polyhydric alcohol, a single or monophase developer is prepared. If the organic solvent is a caprolactam multiple distinct liquid phases are formed. The top layer is the organic solvent layer, whereas the bottom layer is the aqueous phase. By omitting a filtration step, a diphase or triphase developer concentrate depending on the organic solvent can also be prepared.

The invention also contemplates the use of CD-4 salt, and more preferably, the use of the CD-4 base. Use of the CD-4 base will eliminate the filtration step.

In order to demonstrate the invention, the following experiments were conducted:

### EXAMPLE 1

For purposes of comparison a CD-4 developer replenisher concentrate was prepared with hydroxylamine sulfate (HAS), the traditional antioxidant used in multi-part CD-4-containing developers:

| | | |
|---|---|---|
| Water | 800 | ml |
| KBr | 0.8 | g/L |
| caprolactam | 12.0 | g/L |
| Potassium sulfite @ 690 g/L | 8.33 | ml/L |
| CD-4 developer | 5.6 | g/L |
| Additional surfactant | 3.0 | ml/L |
| Hardness sequestrant | 1.0 | ml/L |
| Potassium carbonate (800 g/L) | 46.75 | ml/L |
| HAS | 2.8 | g/L |
| Water to | 1.0 | L |
| pH | 10.20 | |

In the one-part developer environment of alkaline pH, the HAS decomposes, leaving no residual antioxidant to protect the highly reactive CD-4. This formula darkened in three days, an indicator that the CD-4 had decomposed, leaving insufficient active ingredient to provide satisfactory developer performance.

### EXAMPLE 2

To demonstrate the performance of a one-part CD-4 developer replenisher concentrate stabilized with diethylhydroxylamine (DEHA) the following solution was prepared:

| | | |
|---|---|---|
| Water | 800 | ml |
| KBR | 0.8 | g/L |
| caprolactam | 12.0 | g/L |
| Potassium metabisulfite | 2.9 | g/L |
| Potassium sulfite @ 690 g/L | 2.3 | ml/L |
| CD-4 developer | 5.6 | g/L |
| Additional surfactant | 3.0 | ml/L |
| Hardness sequestrant | 2.6 | g/L |
| Potassium carbonate (800 g/L) | 46.75 | ml/L |
| DEHA (85%) | 7.0 | ml/L |
| Water to | 1.0 | L |

| | |
|---|---|
| pH | 10.20 ± 0.02 |

This solution was found to have a shelf life of about one year or less, based on elevated-temperature accelerated aging tests. In addition, this developer solution preserved with DEHA only, did not provide satisfactory developer performance, in that it yielded a high Dₘᵢₙ densitometric result (high stain). This example illustrates the sensitivity of the CD-4 developing agent to competing developer-acting compounds such as DEHA.

### EXAMPLE 3

To further compare the performance of CD-4 developer replenisher stabilized with hydroxylamine antioxidant, a solution was prepared with SEHA disodium salt (sulfonatoethylhydroxylamine disodium salt, monohydrate) with the following formulation:

| | | |
|---|---|---|
| Water | 800 | ml |
| KBR | 0.8 | g/L |
| caprolactam | 12.0 | g/L |
| Potassium metabisulfite | 4.0 | g/L |
| CD-4 developer | 5.6 | g/L |
| Hardness sequestrant | 2.6 | g/L |
| KOH (50%) | 1.5 | ml/L |
| Potassium carbonate (800 g/L) | 46.75 | ml/L |
| SEHA disodium (monohydrate) | 5.0 | g/L |
| Water to | 1.0 | L |

| | |
|---|---|
| pH | 10.10 +/− 0.05 |

This SEHA-only-preserved formula demonstrated a stable shelf life approaching two years, in elevated-temperature accelerated aging tests, and also provided satisfactory developer performance, in particular as regards stain, or Dₘᵢₙ, being kept at acceptably low levels.

### EXAMPLE 4

Additionally, the stability and performance of CD-4 developer replenisher was tested using a combination of hydroxylamine antioxidants. A solution was prepared with SEHA disodium salt (sulfonatoethylhydroxylamine disodium salt, monohydrate) and diethylhydroxylamine (DEHA) in the following formulation:

| | | |
|---|---|---|
| Water | 800 | ml |
| KBR | 0.8 | g/L |
| caprolactam | 12.0 | g/L |
| Potassium metabisulfite | 4.0 | g/L |
| CD-4 developer | 5.6 | g/L |
| Hardness sequestrant | 2.6 | g/L |
| KOH (50%) | 1.5 | ml/L |
| Potassium carbonate (800 g/L) | 46.75 | ml/L |
| SEHA disodium (monohydrate) | 3.0 | g/L |
| DEHA (85%) | 3.0 | ml/L |
| Water to | 1.0 | L |

| | |
|---|---|
| pH | 10.10 ± 0.05 |

This combination SEHA-DEHA-preserved formula demonstrated a stable shelf life of greater than one year in elevated-temperature accelerated aging tests, and also provided satisfactory developer performance, in particular as regards stain, or Dₘᵢₙ, provided the DEHA level is kept sufficiently low as to stimulate its competing development activity in comparison to the CD-4 color developing agent.

I claim:

1. A one-part liquid concentrated color developer replenisher composition, which comprises a 4 (N-ethyl-N-2-hydroxyethyl) -2-methylphenylenediamine-containing developer, and a sufficient amount of a hydroxylamine antioxidant to extend the shelf-life of said composition comprising at least N,N-bis(2-sulfoethyl) hydroxylamine or a salt thereof, said composition further characterized by satisfactory developer performance.

2. The one-part liquid concentrate color developer replenisher composition of claim 1 wherein the hydroxylamine antioxidant is a disodium salt of N,N-bis(2-sulfoethyl)hydroxylamine.

3. The one-part liquid concentrate color developer replenisher composition of claim 1 wherein the hydroxylamine antioxidant comprises at least a salt of the N,N-bis(2-sulfoethyl)hydroxylamine in combination with at least one other hydroxylamine antioxidant.

4. The one-part liquid concentrate color developer replenisher composition of claim 3, wherein the one other hydroxylamine antioxidant is diethylhydroxylamine or a salt thereof.

5. A one-part liquid concentrated color developer replenisher composition, which comprises a 4(N-ethyl-N-2-hydroxyethyl)-2-methylphenylenediamine-containing developer, a shelf-life extending amount of a hydroxylamine antioxidant comprising at least N,N-bis(2-sulfoethyl) hydroxylamine or a salt thereof; a buffer for maintaining the pH of the composition in a range from about 10 to about 12, and a photographically acceptable solvent system, said composition further characterized by satisfactory developer performance.

6. The one-part liquid concentrated color developer replenisher composition of claim 5 which is a monophase concentrate.

7. The one-part liquid concentrated color developer replenisher composition of claim 5 which is a multiphase concentrate.

8. The one-part liquid concentrated color developer replenisher composition of claim 6 wherein the monophase concentrate comprises a polyhydric alcohol.

9. The one-part liquid concentrated color developer replenisher composition of claim 7 wherein the multiphase concentrate comprises an upper caprolactam-containing phase comprising the 4(N-ethyl-N-2-hydroxyethyl)-2-methylphenylenediamine-containing developer and the N,N-bis(2-sulfoethyl) hydroxylamine antioxidant or salt thereof, and a lower aqueous phase comprises the buffer.

10. The one-part liquid concentrated color developer replenisher composition of claim 9 wherein the caprolactam-containing multiphase concentrate comprises a third phase in the form of a solid precipitate comprising a salt.

11. The one-part liquid concentrated color developer replenisher composition of claim 5 which is a diphase concentrate comprising a polyhydric alcohol-containing liquid phase and a solid phase comprising a salt.

12. A method for preparing a stabilized one-part liquid concentrated color developer replenisher composition, which comprises the steps of:
(i) dissolving a 4(N-ethyl-N-2-hydroxyethyl)-2-methyl -phenylenediamine-containing developer in an alkaline solution comprising a base, and an antioxidant comprising at least N,N -bis(2-sulfoethyl)hydroxylamine or a salt thereof;
(ii) introducing a photographically compatible organic solvent, and
(iii) introducing a buffering agent to maintain the pH of the solution in a range from about 10 to about 12, said composition further characterized by satisfactory developer performance.

13. The method of claim 12 wherein the photographically compatible organic solvent is a polyhydric alcohol, and the one -part liquid concentrated developer replenisher composition is a monophase concentrate, said method including the step of removing a salt precipitate.

14. The method of claim 12 wherein the photographically compatible organic solvent is a polyhydric alcohol, and the developer concentrate is a diphase system comprising a liquid phase and a solid phase comprising a salt.

15. The method of claim 12 wherein the photographically compatible organic solvent is a caprolactam which forms a diphase system comprising an upper caprolactam-containing solvent and a lower aqueous phase, said method including the step of removing a salt.
